(19) United States
(12) Patent Application Publication
(10) Pub. No.: US 2025/0291164 A1
(43) Pub. Date: Sep. 18, 2025

(54) Display with a Catadioptric Collimating Lens

(71) Applicant: Apple Inc., Cupertino, CA (US)

(72) Inventors: Scott M DeLapp, San Diego, CA (US); Bradley C Steele, La Jolla, CA (US); Graham C Nelson, San Diego, CA (US); Pablo Benitez Gimenez, Madrid (ES); Pablo Zamora Herranz, Madrid (ES)

(21) Appl. No.: 18/983,042

(22) Filed: Dec. 16, 2024

Related U.S. Application Data
(60) Provisional application No. 63/564,074, filed on Mar. 12, 2024.

(51) Int. Cl. G02B 17/08; G02B 27/01

(52) U.S. Cl. CPC G02B 17/086; G02B 17/0816; G02B 27/0172; G02B 2027/013

(57) ABSTRACT

An electronic device may include a display module that generates image light and an optical system that redirects the image light towards an eye box. The optical system may include an input coupler on a waveguide and collimating optics that collimate the image light between the image light exiting a display module and the image light reaching the input coupler. The collimating optics may include a catadioptric lens that refracts the image light at least twice and reflects the image light at least twice. The catadioptric lens may include first and second lens elements with different refractive indices. The catadioptric lens may include first and second lens elements formed from the same material and attached using optically clear adhesive.

This application claims the benefit of U.S. provisional patent application No. 63/564,074 filed Mar. 12, 2024, which is hereby incorporated by reference herein in its entirety.

### BACKGROUND

This relates generally to optical systems and, more particularly, to optical systems for displays.

Electronic devices may include displays that present images to a user's eyes. For example, devices such as virtual reality and augmented reality headsets may include displays with optical elements that allow users to view the displays.

It can be challenging to design devices such as these. If care is not taken, the components used in displaying content may be unsightly and bulky and may not exhibit desired levels of optical performance.

### SUMMARY

A display system may include a waveguide, a display module that produces image light, and a catadioptric lens that redirects the image light from the display module to the waveguide. The catadioptric lens may be configured to refract the image light at least twice and reflect the image light at least twice.

A display system may include a waveguide, a display module that produces image light, and a catadioptric lens that redirects the image light from the display module to the waveguide. The catadioptric lens may include a first lens element, a second lens element, and optically clear adhesive between the first and second lens elements. The first lens element may have a first surface that directly contacts the optically clear adhesive and a second surface that is coated with a first mirror, the second lens element may have a third surface that directly contacts the optically clear adhesive and a fourth surface that is coated with a second mirror, the image light may be refracted at both the first and third surfaces, the image light may be reflected at both the second and fourth surfaces.

A display system may include a waveguide, a display module that produces image light, and a catadioptric lens that redirects the image light from the display module to the waveguide. The catadioptric lens may include a first lens element having a first refractive index, a second lens element having a second refractive index that is lower than the first refractive index, and optically clear adhesive between the first and second lens elements. The optically clear adhesive may have the second refractive index and the second lens element may have a surface that is coated with a mirror.

### BRIEF DESCRIPTION OF THE DRAWINGS

FIG. 1 is a diagram of an illustrative system having a display in accordance with some embodiments.

FIG. 2A is a top view of an illustrative display system with a single display module, a waveguide, and collimating optics in accordance with some embodiments.

FIG. 2B is a top view of an illustrative display system with multiple display modules, an optical combiner for the multiple display modules, a waveguide, and collimating optics in accordance with some embodiments.

FIG. 3 is a top view of an illustrative display system with a 5-surface catadioptric collimating lens in accordance with some embodiments.

FIG. 4 is a top view of an illustrative display system with a 4-surface catadioptric collimating lens in accordance with some embodiments.

FIG. 5 is a top view of an illustrative display system with a 5-surface catadioptric collimating lens that includes first and second lens elements with different refractive indices in accordance with some embodiments.

FIG. 6 is a top view of an illustrative display system with a 6-surface catadioptric collimating lens that includes first and second lens elements in accordance with some embodiments.

FIG. 7 is a top view of an illustrative display system with a 3-surface catadioptric collimating lens in accordance with some embodiments.

FIG. 8 is a top view of an illustrative display system with a 4-surface catadioptric collimating lens that receives tilted image light in accordance with some embodiments.

FIG. 9 is a top view of an illustrative display system with a 6-surface catadioptric collimating lens that includes first and second lens elements and that receives tilted image light in accordance with some embodiments.

### DETAILED DESCRIPTION

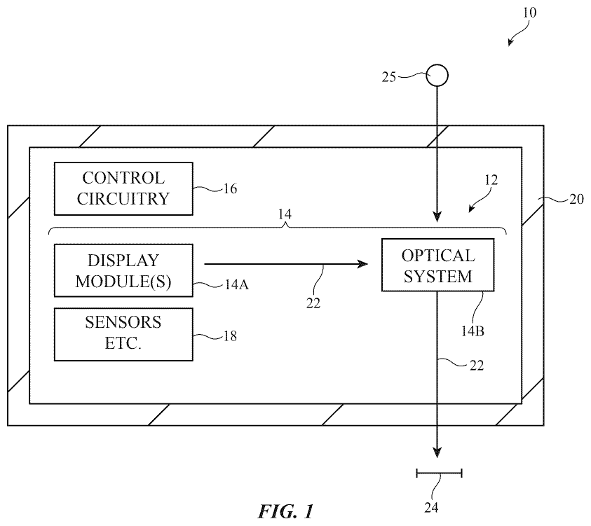

An illustrative system having a device with one or more near-eye display systems is shown in FIG. 1. System 10 may be a head-mounted device having one or more displays such as near-eye displays 14 (sometimes referred to as display systems 14 or near-eye display systems 14) mounted within support structure (housing) 20. Support structure 20 may have the shape of a pair of eyeglasses (e.g., supporting frames), may form a housing having a helmet shape, or may have other configurations to help in mounting and securing the components of near-eye displays 14 on the head or near the eye of a user. Near-eye displays 14 may include one or more display modules such as display modules 14A and one or more optical systems such as optical systems 14B. Display modules 14A may be mounted in a support structure such as support structure 20. Each display module 14A may emit light 22 (image light) that is redirected towards a user's eyes at eye box 24 using an associated one of optical systems 14B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code (instructions) may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Display modules 14A may include reflective displays (e.g., liquid crystal on silicon (LCOS) displays, digital-micromirror device (DMD) displays, or other spatial light modulators), emissive displays (e.g., micro-light-emitting diode (uLED) displays, organic light-emitting diode (OLED) displays, laser-based displays, etc.), or displays of other types. Light sources in display modules 14A may include uLEDs, OLEDs, LEDs, lasers, combinations of these, or any other desired light-emitting components.

Optical systems 14B may form lenses that allow a viewer (see, e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple displays (e.g., left and right eye displays), the focal length and positions of the lenses formed by components in optical system 14B may be selected so that any gap present between the displays will not be visible to a user (e.g., so that the images of the left and right displays overlap or merge seamlessly).

If desired, optical system 14B may contain components (e.g., an optical combiner, etc.) to allow real-world image light from real-world images or objects 25 to be combined optically with virtual (computer-generated) images such as virtual images in image light 22. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement which a camera captures real-world images of object 25 and this content is digitally merged with virtual content at optical system 14B).

System 10 may, if desired, include wireless circuitry and/or other circuitry to support communications with a computer or other external equipment (e.g., a computer that supplies display 14 with image content). During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

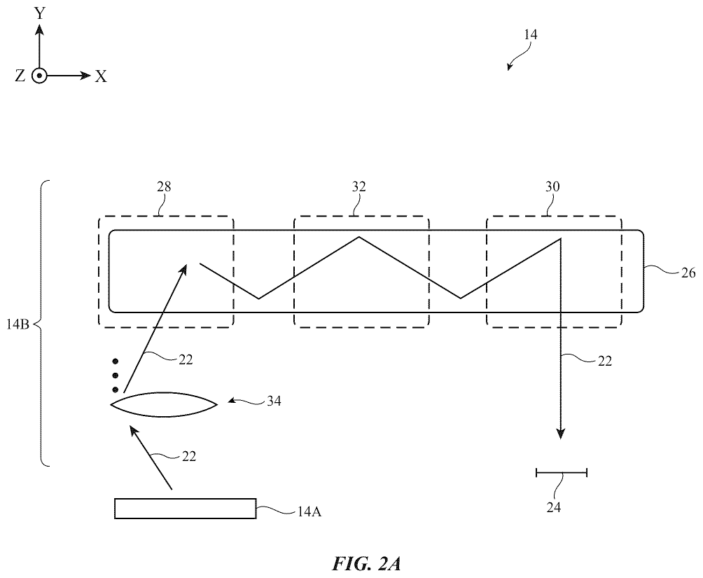

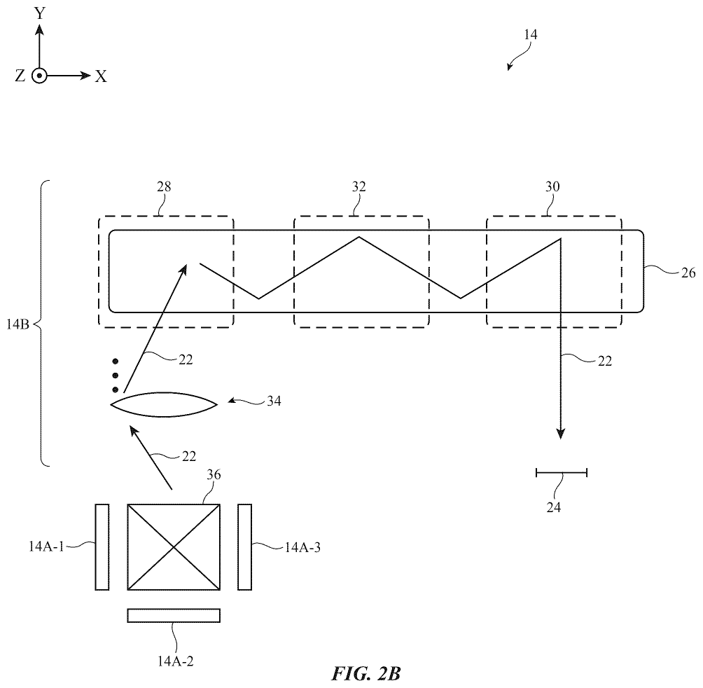

FIG. 2A is a top view of an illustrative display 14 that may be used in system 10 of FIG. 1. As shown in FIG. 2A, near-eye display 14 may include one or more display modules such as display module 14A and an optical system such as optical system 14B. Optical system 14B may include optical elements such as one or more waveguides 26. Waveguide 26 may include one or more stacked substrates (e.g., stacked planar and/or curved layers sometimes referred to herein as waveguide substrates) of optically transparent material such as plastic, polymer, glass, etc.

If desired, waveguide 26 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 26 may include holographic phase gratings such as volume holograms or thin-film holograms, meta-gratings, or any other desired diffractive grating structures. The diffractive gratings on waveguide 26 may also include surface relief gratings formed on one or more surfaces of the substrates in waveguides 26, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles).

Optical system 14B may include collimating optics such as collimating optics 34 (sometimes referred to as collimating lens 34). Collimating lens 34 may include one or more lens elements and/or mirrors that help direct image light 22 towards waveguide 26. If desired, display module 14A may be mounted within support structure 20 of FIG. 1 while optical system 14B may be mounted between portions of support structure 20 (e.g., to form a lens that aligns with eye box 24). Other mounting arrangements may be used, if desired.

As shown in FIG. 2A, display module 14A may generate light 22 associated with image content to be displayed to eye box 24. Light 22 may be collimated using collimating optics 34. Optical system 14B may be used to present light 22 output from display module 14A to eye box 24.

Optical system 14B may include one or more optical couplers such as input coupler 28, cross-coupler 32, and output coupler 30. In the example of FIG. 2A, input coupler 28, cross-coupler 32, and output coupler 30 are formed at or on waveguide 26. Input coupler 28, cross-coupler 32, and/or output coupler 30 may be completely embedded within the substrate layers of waveguide 26, may be partially embedded within the substrate layers of waveguide 26, may be mounted to waveguide 26 (e.g., mounted to an exterior surface of waveguide 26), etc.

The example of FIG. 2A is merely illustrative. One or more of these couplers (e.g., cross-coupler 32) may be omitted. Optical system 14B may include multiple waveguides that are laterally and/or vertically stacked with respect to each other. Each waveguide may include one, two, all, or none of couplers 28, 32, and 30. Waveguide 26 may be at least partially curved or bent if desired.

Waveguide 26 may guide light 22 down its length via total internal reflection. Input coupler 28 may be configured to couple light 22 from display module 14A (lens 34) into waveguide 26, whereas output coupler 30 may be configured to couple light 22 from within waveguide 26 to the exterior of waveguide 26 and towards eye box 24. For example, display module 14A may emit light 22 in direction +Y towards optical system 14B. When light 22 strikes input coupler 28, input coupler 28 may redirect light 22 so that the light propagates within waveguide 26 via total internal reflection towards output coupler 30 (e.g., in the positive X-direction). When light 22 strikes output coupler 30, output coupler 30 may redirect light 22 out of waveguide 26 towards eye box 24 (e.g., in the negative Y-direction). In scenarios where cross-coupler 32 is formed at waveguide 26, cross-coupler 32 may redirect light 22 in one or more directions as it propagates down the length of waveguide 26, for example.

Input coupler 28, cross-coupler 32, and/or output coupler 30 may be based on reflective and refractive optics or may be based on holographic (e.g., diffractive) optics. In arrangements where couplers 28, 30, and 32 are formed from reflective and refractive optics, couplers 28, 30, and 32 may include one or more reflectors (e.g., an array of micromirrors, partial mirrors, or other reflectors). In arrangements where couplers 28, 30, and 32 are based on holographic optics, couplers 28, 30, and 32 may include diffractive gratings (e.g., volume holograms, surface relief gratings, etc.).

In the example of FIG. 2A, a single display module 14A emits image light 22 into waveguide 26 via collimating optics 34 and input coupler 28. The example of including only a single display module is merely illustrative. In another possible arrangement, shown in FIG. 2B, multiple display modules may be included. As shown in FIG. 2B, display 14 may include display modules 14A-1, 14A-2, and 14A-3 that are all associated with a single optical system 14B. As an example, the display modules may emit different colors of light (e.g., display module 14A-1 may emit red light, display module 14A-2 may emit blue light, and display module 14A-3 may emit green light).

When multiple display modules are included for a single optical system 14B, display 14 may include an optical combiner 36 (sometimes referred to as prism 36, X-cube 36, etc.). Optical combiner 36 may combine the light emitted by display modules 14A-1, 14A-2, and 14A-3 into image light 22 (e.g., image light 22 may include red, green, and blue light). The optical combiner may include angled surfaces that selectively reflect light based on color.

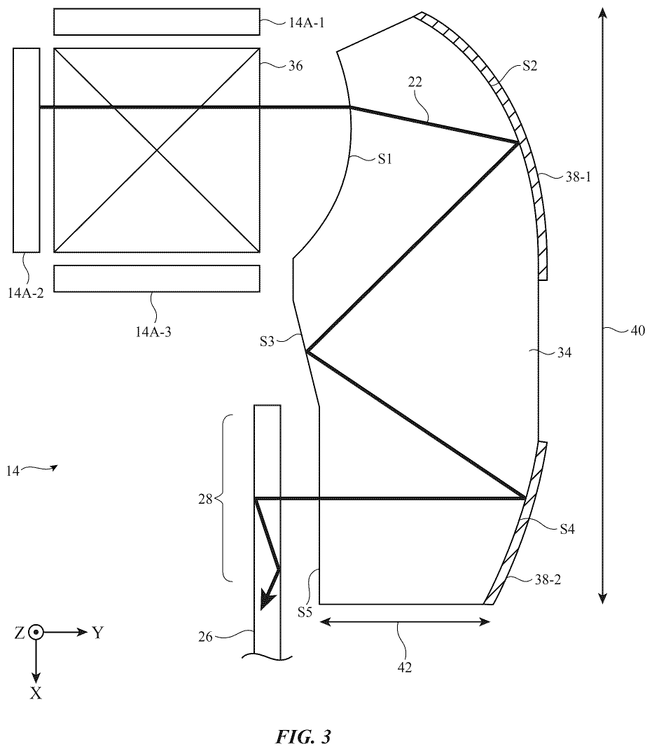

It may be desirable for collimating optics 34 to occupy a small volume in order to reduce the total size of electronic device 10. In some cases, collimating optics 34 may include a catadioptric lens element that both reflects and refracts the image light in order to provide a compact arrangement that collimates the image light. The catadioptric lens element may reflect the image light at least twice and may refract the image light at least twice. FIGS. 3-9 are top views of illustrative catadioptric collimating lenses 34.

As shown in FIG. 3, catadioptric collimating lens element 34 (sometimes referred to as lens element 34, lens 34, catadioptric lens element 34, catadioptric lens 34, catadioptric collimating lens 34, etc.) may include a plurality of discrete surfaces that reflect and refract image light 22 as the image light passes through the lens element. In the example of FIG. 3, lens element 34 includes 5 functional surfaces that reflect or refract light. The lens element of FIG. 3 may therefore sometimes be referred to as a 5-surface lens element.

As shown in FIG. 3, a first surface S1 receives the light from optical combiner 36. Image light 22 is refracted when entering lens element 34 through surface S1. The image light is then incident upon surface S2 of lens element 34. A reflective layer 38-1 is formed on surface S2 and reflects the image light 22 towards surface S3. The image light is then incident upon surface S3 of lens element 34. The image light may reflect off of surface S3 due to the principle of total internal reflection (TIR). The image light is then incident upon surface S4 of lens element 34. A reflective layer 38-2 is formed on surface S4 and reflects the image light 22 towards surface S5. Image light 22 is refracted when exiting lens element 34 through surface S5. To summarize, lens element 34 of FIG. 3 refracts the image light twice (once at surface S1 and once at surface S5) and reflects the image light three times (once at surface S2, once at surface S3, and once at surface S4).

After exiting lens element 34, image light 22 is incident upon waveguide 26 and may be coupled into the waveguide by input coupler 28.

Reflective layers 38-1 and 38-2 may have a reflectance that is greater than 80%, greater than 90%, greater than 95%, greater than 98%, etc. The reflective layers 38 may sometimes be referred to as mirrors 38. Mirrors 38 may have a reflectance that is greater than 70%, greater than 80%, greater than 90%, greater than 95%, greater than 98%, etc. The mirrors may be formed as coatings, films, or solid pieces. The mirrors may be attached or coated to a surface of lens element 34.

Lens element 34 may be formed from plastic, glass, or another desired transparent material. Lens element 34 may have a transparency that is greater than 70%, greater than 80%, greater than 90%, greater than 95%, greater than 98%, etc. The refractive index of lens element 34 may be greater than 1.3, greater than 1.4, greater than 1.5, greater than 1.6, greater than 1.7, greater than 1.8, etc.

Each one of surfaces S1, S2, S3, S4, and S5 in FIG. 3 may be a planar surface, a convex surface (e.g., a spherically convex surface, a cylindrically convex surface, or an cylindrically concave surface, or an aspherically concave surface), or a freeform surface. A freeform surface may include two or more of planar portions, convex portions, and concave portions. A freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In FIG. 3, surface S1 is concave, surfaces S2 and S4 are convex, and surfaces S3 and S5 are planar.

Lens element 34 in FIG. 3 may have a dimension 40 parallel to the X-axis and a dimension 42 parallel to the Y-axis. Dimension 40 may be greater than 6 millimeters, greater than 9 millimeters, greater than 12 millimeters, less than 15 millimeters, etc. Dimension 42 may be greater than 2 millimeters, greater than 3 millimeters, greater than 5 millimeters, less than 6 millimeters, less than 5 millimeters, less than 4 millimeters, etc. As one specific example, dimension 40 may be less than 13 millimeters and dimension 42 may be less than 5 millimeters.

It is noted that lens element 34 may have additional non-functional surfaces not explicitly labeled in FIG. 3. These non-functional surfaces do not reflect or refract the image light and therefore the curvature of these surfaces does not impact the optical performance of lens 34. The shape of these non-functional surfaces may be selected to simplify manufacturing, as one example.

To simplify the manufacturing of lens element 34 and/or to reduce the size of lens element 34, the lens element may have 4 functional surfaces that reflect or refract light (instead of 5 functional surfaces as in FIG. 3).

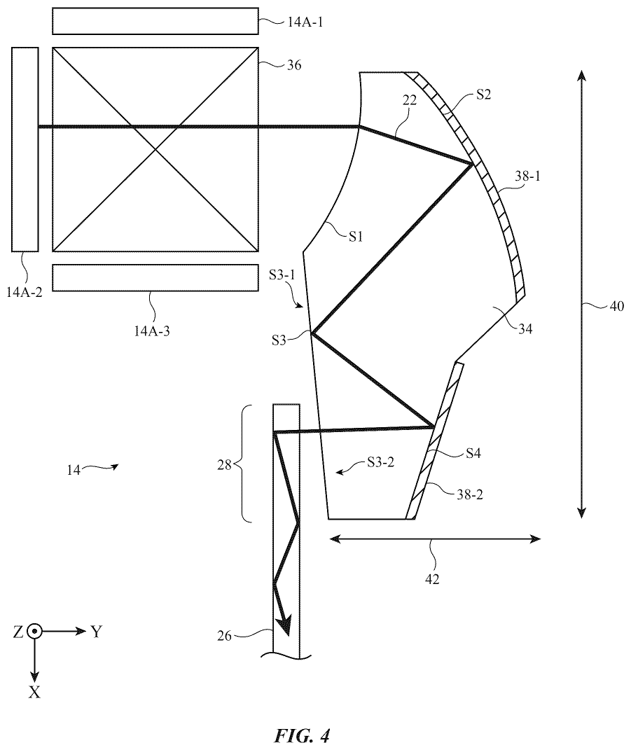

In the example of FIG. 4, lens element 34 includes 4 functional surfaces that reflect or refract light. The lens element of FIG. 4 may therefore sometimes be referred to as a 4-surface lens element.

As shown in FIG. 4, a first surface S1 receives the light from optical combiner 36. Image light 22 is refracted when entering lens element 34 through surface S1. The image light is then incident upon surface S2 of lens element 34. A reflective layer 38-1 is formed on surface S2 and reflects the image light 22 towards surface S3. The image light is then incident upon portion S3-1 of surface S3 of lens element 34. The image light may reflect off of surface S3 due to the principle of total internal reflection (TIR). The image light is then incident upon surface S4 of lens element 34. A reflective layer 38-2 is formed on surface S4 and reflects the image light 22 back towards surface S3. Image light 22 is refracted when exiting lens element 34 through portion S3-2 of surface S3. To summarize, lens element 34 of FIG. 4 refracts the image light twice (once at surface S1 and once at portion S3-2 of surface S3) and reflects the image light three times (once at surface S2, once at portion S3-1 of surface S3, and once at surface S4). Surface S3 therefore both reflects the image light using total internal reflection (at portion S3-1) and refracts the image light exiting the lens element (at portion S3-2).

After exiting lens element 34, image light 22 is incident upon waveguide 26 and may be coupled into the waveguide by input coupler 28.

Each one of surfaces S1, S2, S3, and S4 in FIG. 4 may be a planar surface, a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. In one specific example, surface S1 is concave, surface S2 is convex, and surfaces S3 and S4 are planar.

Lens element 34 in FIG. 3 may have a dimension 40 parallel to the X-axis and a dimension 42 parallel to the Y-axis. Dimension 40 may be greater than 5 millimeters, greater than 6 millimeters, greater than 7 millimeters, less than 10 millimeters, less than 8 millimeters, etc. Dimension 42 may be greater than 2 millimeters, greater than 3 millimeters, greater than 5 millimeters, less than 6 millimeters, less than 5 millimeters, less than 4 millimeters, etc. As one specific example, dimension 40 may be less than 7 millimeters and dimension 42 may be less than 4 millimeters. Lens element 34 in FIG. 4 (with 4 functional surfaces) may have a smaller volume than lens element 34 in FIG. 3 (with 5 functional surfaces).

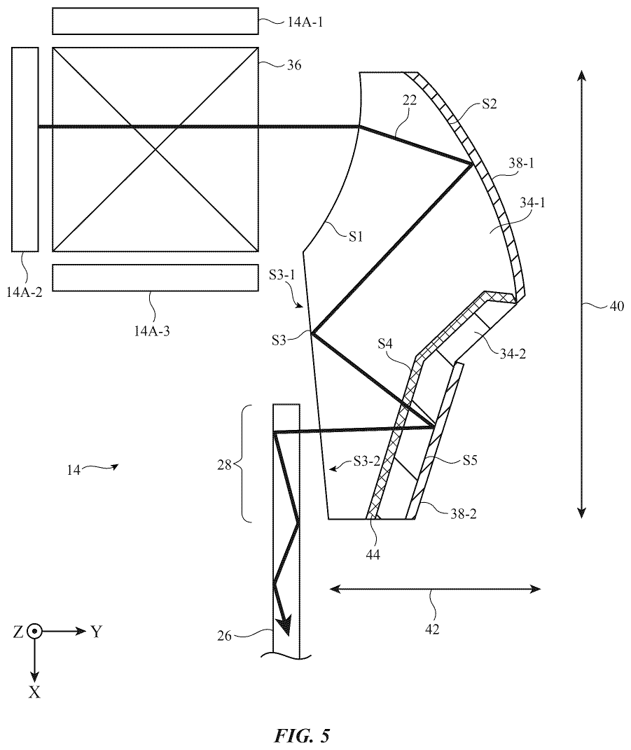

To enjoy the benefits of the smaller volume of the lens element of FIG. 4 while adding an additional functional surface for an additional degree of freedom, a low-index lens element may be attached to lens element 34 as shown in the example of FIG. 5.

As shown in FIG. 5, a first lens element 34-1 (with 4 functional surfaces similar to as shown in FIG. 4) is attached to a second lens element 34-2 using optically clear adhesive 44.

Lens element 34-1 may be formed from plastic, glass, or another desired transparent material. Lens element 34-1 may have a transparency that is greater than 70%, greater than 80%, greater than 90%, greater than 95%, greater than 98%, etc. The refractive index of lens element 34-1 may be greater than 1.3, greater than 1.4, greater than 1.5, greater than 1.6, greater than 1.7, greater than 1.8, etc.

Lens element 34-2 may be formed from plastic, glass, or another desired transparent material. Lens element 34-2 may have a transparency that is greater than 70%, greater than 80%, greater than 90%, greater than 95%, greater than 98%, etc. The refractive index of lens element 34-2 may be less than 1.3, less than 1.4, less than 1.5, less than 1.6, less than 1.7, etc. Lens element 34-2 may have a lower refractive index than lens element 34-1. The difference between the refractive indices of lens elements 34-1 and 34-2 may be greater than 0.05, greater than 0.1, greater than 0.2, greater than 0.3, greater than 0.4, etc.

The optically clear adhesive (OCA) 44 may be index matched to lens element 34-2. The difference between the refractive indices of optically clear adhesive 44 and lens element 34-2 may be less than 0.1, less than 0.05, less than 0.03, less than 0.01, etc.

As shown in FIG. 5, a first surface S1 receives the light from optical combiner 36. Image light 22 is refracted when entering lens element 34-1 through surface S1. The image light is then incident upon surface S2 of lens element 34-1. A reflective layer 38-1 is formed on surface S2 and reflects the image light 22 towards surface S3. The image light is then incident upon portion S3-1 of surface S3 of lens element 34-1. The image light may reflect off of surface S3 due to the principle of total internal reflection (TIR). The image light is then incident upon surface S4 of lens element 34-1. Image light 22 is refracted when exiting lens element 34-1 through surface S4 into lens element 34-2 (and intervening OCA 44). A reflective layer 38-2 is formed on surface S5 of lens element 34-2 and reflects the image light 22 back towards surface S4. Image light 22 is refracted when exiting lens element 34-2 (and OCA 44) through surface S4 back into lens element 34-1. Image light 22 is then refracted when exiting lens element 34-1 through portion S3-2 of surface S3. Surface S4 directly contacts OCA 44.

Lens elements 34-1 and 34-2 may collectively be referred to as a catadioptric collimating lens 34. Lens 34 of FIG. 5 refracts the image light four times (once at surface S1, twice at surface S4, and once at portion S3-2 of surface S3) and reflects the image light three times (once at surface S2, once at portion S3-1 of surface S3, and once at surface S5). Surface S3 therefore both reflects the image light using total internal reflection (at portion S3-1) and refracts the image light exiting the lens element (at portion S3-2).

After exiting lens element 34-1, image light 22 is incident upon waveguide 26 and may be coupled into the waveguide by input coupler 28.

Each one of surfaces S1, S2, S3, S4, and S5 in FIG. 5 may be a planar surface, a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. In one specific example, surface S1 is concave, surface S2 is convex, and surfaces S3, S4, and S5 are planar.

Lens 34 in FIG. 5 may have a dimension 40 parallel to the X-axis and a dimension 42 parallel to the Y-axis. Dimension 40 may be greater than 5 millimeters, greater than 6 millimeters, greater than 7 millimeters, less than 10 millimeters, less than 8 millimeters, etc. Dimension 42 may be greater than 2 millimeters, greater than 3 millimeters, greater than 5 millimeters, less than 6 millimeters, less than 5 millimeters, less than 4 millimeters, etc. As one specific example, dimension 40 may be less than 7 millimeters and dimension 42 may be less than 4 millimeters. Lens element 34 in FIG. 5 (with 5 functional surfaces defined by two lens elements) may have a smaller volume than lens element 34 in FIG. 3 (with 5 functional surfaces defined by a single lens element).

The example in FIG. 5 of lens element 34-2 being attached to lens element 34-1 using OCA 44 is merely illustrative. If desired, lens element 34-1 may be overmolded over lens element 34-2 such that OCA 44 may be omitted.

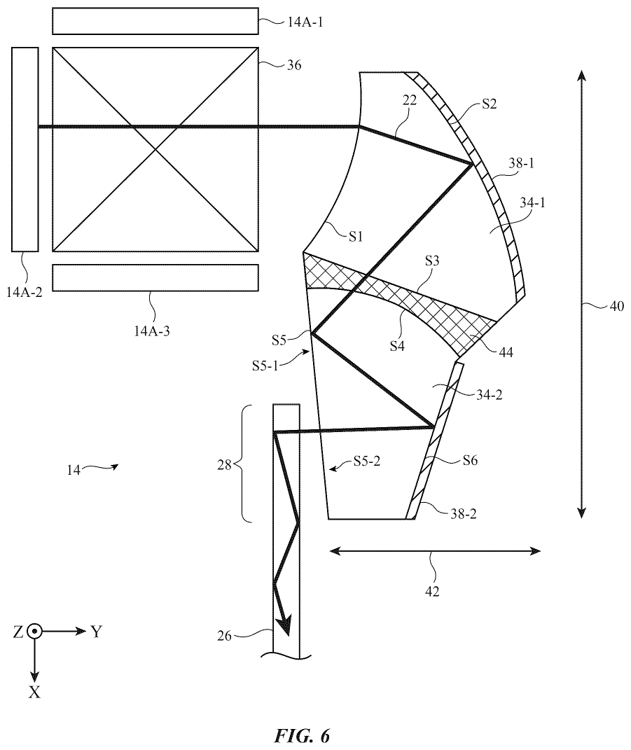

To enjoy the benefits of the smaller volume of the lens element of FIG. 4 while adding two additional functional surfaces for two additional degrees of freedom, the 4-surface lens element may be split into two pieces with an intervening optically clear adhesive layer as shown in the example of FIG. 6.

As shown in FIG. 6, a first lens element 34-1 is attached to a second lens element 34-2 using optically clear adhesive 44. OCA 44 may optionally be omitted and an air gap may be included between lens elements 34-1 and 34-2 if desired.

Lens element 34-1 may be formed from plastic, glass, or another desired transparent material. Lens element 34-1 may have a transparency that is greater than 70%, greater than 80%, greater than 90%, greater than 95%, greater than 98%, etc. The refractive index of lens element 34-1 may be greater than 1.3, greater than 1.4, greater than 1.5, greater than 1.6, greater than 1.7, greater than 1.8, etc.

Lens element 34-2 may be formed from plastic, glass, or another desired transparent material. Lens element 34-2 may have a transparency that is greater than 70%, greater than 80%, greater than 90%, greater than 95%, greater than 98%, etc. The refractive index of lens element 34-2 may be greater than 1.3, greater than 1.4, greater than 1.5, greater than 1.6, greater than 1.7, greater than 1.8, etc.

Lens elements 34-1 and 34-2 may be formed from the same material (in which case the refractive indices of the lens elements may be the same) or from different materials. In the case of the lens elements being formed from different materials, the difference in refractive index between lens elements 34-1 and 34-2 may be less than 0.3, less than 0.2, less than 0.1, less than 0.05, less than 0.03, less than 0.01, etc.

Optically clear adhesive 44 may have a different refractive index than lens elements 34-1 and 34-2 such that the image light is refracted when entering and exiting the optically clear adhesive. The difference in refractive index between OCA 44 and lens element 34-1 may be greater than 0.05, greater than 0.1, greater than 0.2, greater than 0.3, greater than 0.4, etc. The difference in refractive index between OCA 44 and lens element 34-2 may be greater than 0.05, greater than 0.1, greater than 0.2, greater than 0.3, greater than 0.4, etc.

As shown in FIG. 6, a first surface S1 receives the light from optical combiner 36. Image light 22 is refracted when entering lens element 34-1 through surface S1. The image light is then incident upon surface S2 of lens element 34-1. A reflective layer 38-1 is formed on surface S2 and reflects the image light 22 towards surface S3. The image light is refracted when passing through surface S3 from lens element 34-1 into OCA 44. The image light is then refracted again when passing through surface S4 from OCA 44 into lens element 34-2. The image light is then incident upon portion S5-1 of surface S5 of lens element 34-2. The image light may reflect off of surface S5 due to the principle of total internal reflection (TIR). The image light is then incident upon surface S6 of lens element 34-2. A reflective layer 38-2 is formed on surface S6 of lens element 34-2 and reflects the image light 22 back towards surface S5. Image light 22 is then refracted when exiting lens element 34-2 through portion S5-2 of surface S5. Surfaces S3 and S4 directly contact OCA 44.

Lens elements 34-1 and 34-2 may collectively be referred to as a catadioptric collimating lens 34. Lens 34 of FIG. 6 refracts the image light four times (once at surface S1, once at surface S3, once at surface S4, and once at portion S5-2 of surface S5) and reflects the image light three times (once at surface S2, once at portion S5-1 of surface S5, and once at surface S6). Surface S5 therefore both reflects the image light using total internal reflection (at portion S5-1) and refracts the image light exiting the lens element (at portion S5-2).

After exiting lens element 34-2, image light 22 is incident upon waveguide 26 and may be coupled into the waveguide by input coupler 28.

Each one of surfaces S1, S2, S3, S4, S5, and S6 in FIG. 6 may be a planar surface, a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. In one specific example, surface S1 is concave, surfaces S2 and S4 are convex, and surfaces S3, S5 and S6 are planar.

Lens 34 in FIG. 6 may have a dimension 40 parallel to the X-axis and a dimension 42 parallel to the Y-axis. Dimension 40 may be greater than 5 millimeters, greater than 6 millimeters, greater than 7 millimeters, less than 10 millimeters, less than 8 millimeters, etc. Dimension 42 may be greater than 2 millimeters, greater than 3 millimeters, greater than 5 millimeters, less than 6 millimeters, less than 5 millimeters, less than 4 millimeters, etc. As one specific example, dimension 40 may be less than 7 millimeters and dimension 42 may be less than 4 millimeters. Lens element 34 in FIG. 6 (with 6 functional surfaces defined by two lens elements) may have a smaller volume than lens element 34 in FIG. 3 (with 5 functional surfaces defined by a single lens element).

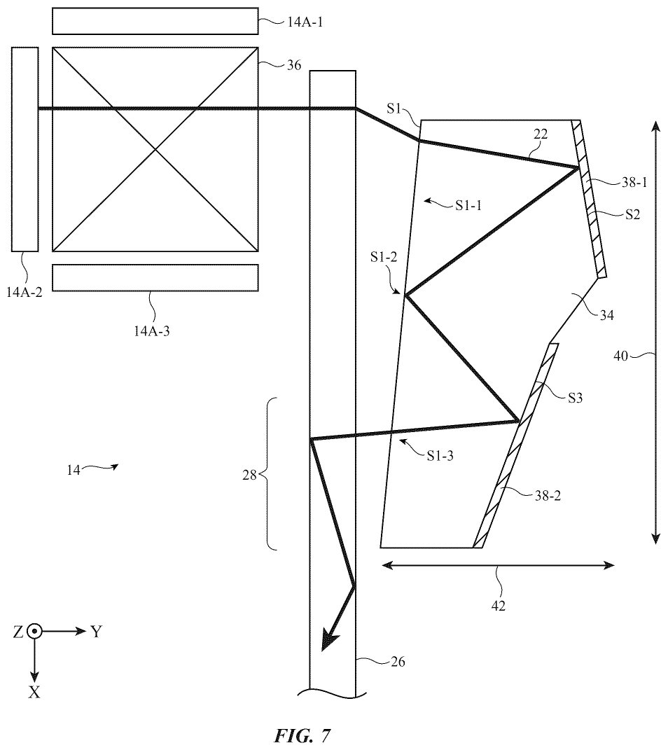

To simplify the manufacturing of lens 34 and/or to reduce the size of lens 34, the lens may have 3 functional surfaces that reflect or refract light (instead of 4 as in FIG. 4). In the example of FIG. 7, lens element 34 includes 3 functional surfaces that reflect or refract light. The lens element of FIG. 7 may therefore sometimes be referred to as a 3-surface lens element.

As shown in FIG. 7, a first portion S1-1 of a first surface S1 receives the light from optical combiner 36 (and intervening waveguide 26). Image light 22 is refracted when entering lens element 34 through surface S1. The image light is then incident upon surface S2 of lens element 34. A reflective layer 38-1 is formed on surface S2 and reflects the image light 22 back towards surface S1. The image light is then incident upon portion S1-2 of surface S1 of lens element 34. The image light may reflect off of surface S1 due to the principle of total internal reflection (TIR). The image light is then incident upon surface S3 of lens element 34. A reflective layer 38-2 is formed on surface S3 and reflects the image light 22 back towards surface S1. Image light 22 is refracted when exiting lens element 34 through portion S1-3 of surface S1. To summarize, lens element 34 of FIG. 4 refracts the image light twice (once at portion S1-1 of surface S1 and once at portion S1-3 of surface S1) and reflects the image light three times (once at surface S2, once at portion S1-2 of surface S1, and once at surface S3). Surface S1 therefore refracts the image light entering the lens element (at portion S1-1), reflects the image light using total internal reflection (at portion S1-2), and refracts the image light exiting the lens element (at portion S1-3).

After exiting lens element 34, image light 22 is incident upon waveguide 26 and may be coupled into the waveguide by input coupler 28.

Each one of surfaces S1, S2, and S3 in FIG. 7 may be a planar surface, a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. In one specific example, surfaces S1, S2, and S3 are all planar.

Lens element 34 in FIG. 7 may have a dimension 40 parallel to the X-axis and a dimension 42 parallel to the Y-axis. Dimension 40 may be greater than 5 millimeters, greater than 6 millimeters, greater than 7 millimeters, less than 10 millimeters, less than 8 millimeters, etc. Dimension 42 may be greater than 2 millimeters, greater than 3 millimeters, greater than 5 millimeters, less than 6 millimeters, less than 5 millimeters, less than 4 millimeters, etc. Lens element 34 in FIG. 7 (with 3 functional surfaces) may have a smaller volume than lens element 34 in FIG. 3 (with 5 functional surfaces).

In the example of FIG. 7, image light exits optical combiner 36 and passes through waveguide 26 before being incident upon lens 34. The portion of waveguide 26 that receives the light from optical combiner 36 may refract the image light and therefore may be considered part of the collimating optics for the optical system. The example of waveguide 26 being interposed in the optical path of image light between optical combiner 36 and lens element 34 in FIG. 7 is merely illustrative. If desired, the waveguide may not be interposed between optical combiner 36 and lens element 34 in FIG. 7 if desired. Similarly, the waveguide may optionally be interposed in the optical path of image light between optical combiner 36 and lens 34 in FIGS. 3-6 if desired.

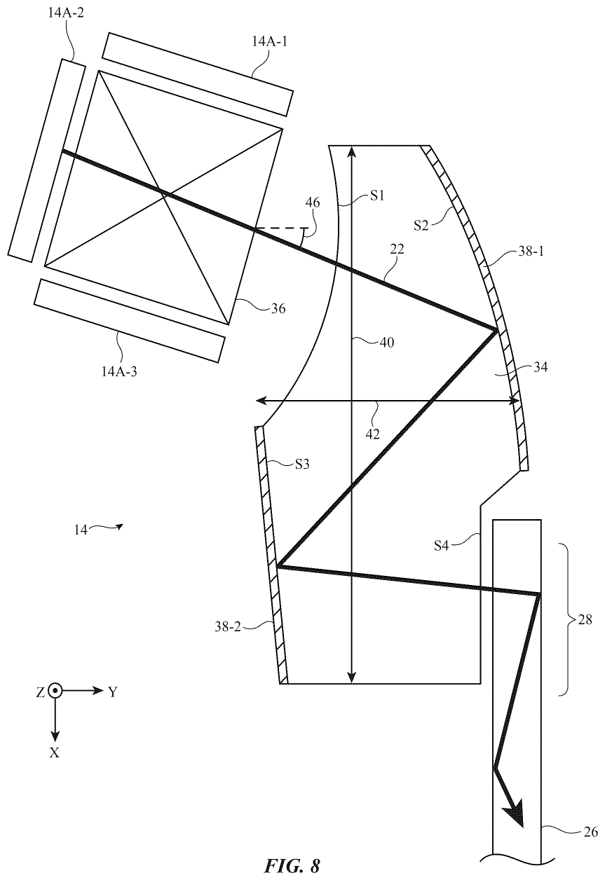

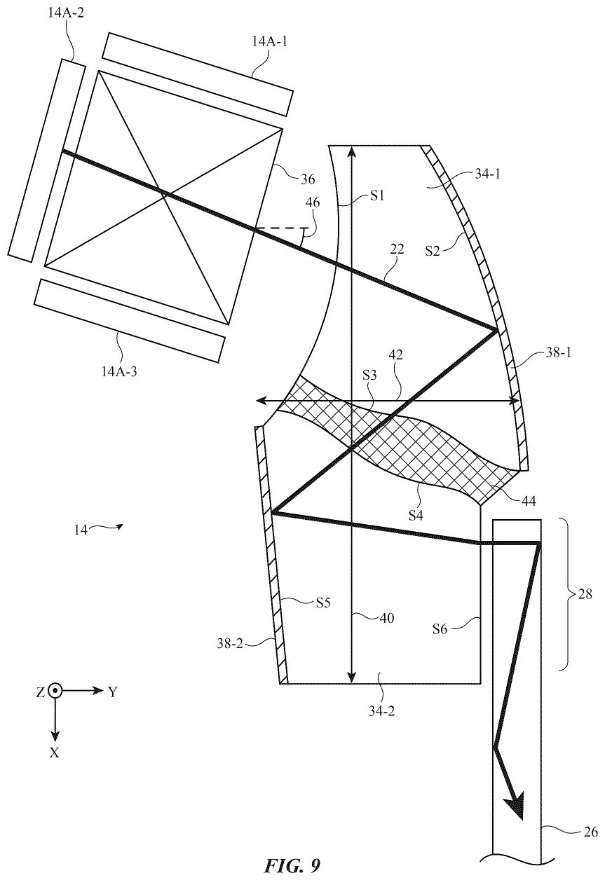

In FIGS. 3-7, the optical combiner 36 and display modules 14A-1, 14A-2, and 14A-3 are all formed on the negative Y-side of waveguide 26 whereas catadioptric collimating lens 34 is formed on the positive Y-side of waveguide 26. In other words, components 36, 14A-1, 14A-2, and 14A-3 and lens 34 are formed on opposing sides of waveguide 26. This may be advantageous for fitting the components within the volume of some electronic devices. In other electronic devices, it may be desirable to consolidate these components on one side of the waveguide. FIGS. 8 and 9 show examples of this type.

In FIGS. 8 and 9, the optical combiner 36, display modules 14A-1, 14A-2, and 14A-3, and catadioptric lens 34 are all formed on the same side (e.g., the negative Y-side) of waveguide 26.

In the example of FIG. 8, lens element 34 includes 4 functional surfaces that reflect or refract light. The lens element of FIG. 8 may therefore sometimes be referred to as a 4-surface lens element.

As shown in FIG. 8, a first surface S1 receives the light from optical combiner 36. Image light 22 is refracted when entering lens element 34 through surface S1. The image light is then incident upon surface S2 of lens element 34. A reflective layer 38-1 is formed on surface S2 and reflects the image light 22 towards surface S3. A reflective layer 38-2 is formed on surface S3 and reflects the image light 22 towards surface S4. Image light 22 is refracted when exiting lens element 34 through surface S4. To summarize, lens element 34 of FIG. 7 refracts the image light twice (once at surface S1 and once at surface S4) and reflects the image light twice (once at surface S2 and once at surface S3).

After exiting lens element 34, image light 22 is incident upon waveguide 26 and may be coupled into the waveguide by input coupler 28.

Each one of surfaces S1, S2, S3, and S4 in FIG. 8 may be a planar surface, a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. In one specific example, surface S1 is concave, surfaces S2 and S3 are convex, and surface S4 is planar.

Lens element 34 in FIG. 8 may have a dimension 40 parallel to the X-axis and a dimension 42 parallel to the Y-axis. Dimension 40 may be greater than 5 millimeters, greater than 6 millimeters, greater than 7 millimeters, less than 10 millimeters, less than 8 millimeters, etc. Dimension 42 may be greater than 2 millimeters, greater than 3 millimeters, greater than 5 millimeters, less than 6 millimeters, less than 5 millimeters, less than 4 millimeters, etc. As one specific example, dimension 40 may be less than 7 millimeters and dimension 42 may be less than 4 millimeters. Lens element 34 in FIG. 8 (with 4 functional surfaces) may have a smaller volume than lens element 34 in FIG. 3 (with 5 functional surfaces).

FIG. 8 also shows how catadioptric collimating lens 34 may receive light at an angle relative to the Y-axis. In FIGS. 3-7, the principle ray of light received at lens 34 may be parallel to the Y-axis and travel in the positive Y-direction. In FIG. 8, in contrast, the principle ray of light received at lens 34 is at a non-zero angle 46 relative to the Y-axis. The magnitude of angle 46 may be at least 5 degrees, at least 15 degrees, at least 25 degrees, at least 35 degrees, at least 45 degrees, less than 45 degrees, less than 35 degrees, less than 25 degrees, between 5 degrees and 45 degrees, between 5 degrees and 35 degrees, etc. The arrangement of FIG. 8 may be referred to as a tilted light source.

Using a tilted light source as in FIG. 8 may help collimate the light for input coupler 28 and mitigate artifacts within the optical system. Any of the optical systems of FIGS. 3-7 may optionally use a tilted light source (as in FIG. 8) if desired.

To add two additional functional surfaces for two additional degrees of freedom, the 4-surface lens element may be split into two pieces with an intervening optically clear adhesive layer as shown in the example of FIG. 9.

As shown in FIG. 9, a first lens element 34-1 is attached to a second lens element 34-2 using optically clear adhesive 44. OCA 44 may optionally be omitted and an air gap may be included between lens elements 34-1 and 34-2 if desired.

Lens element 34-1 may be formed from plastic, glass, or another desired transparent material. Lens element 34-1 may have a transparency that is greater than 70%, greater than 80%, greater than 90%, greater than 95%, greater than 98%, etc. The refractive index of lens element 34-1 may be greater than 1.3, greater than 1.4, greater than 1.5, greater than 1.6, greater than 1.7, greater than 1.8, etc.

Lens element 34-2 may be formed from plastic, glass, or another desired transparent material. Lens element 34-2 may have a transparency that is greater than 70%, greater than 80%, greater than 90%, greater than 95%, greater than 98%, etc. The refractive index of lens element 34-2 may be greater than 1.3, greater than 1.4, greater than 1.5, greater than 1.6, greater than 1.7, greater than 1.8, etc.

Lens elements 34-1 and 34-2 may be formed from the same material (in which case the refractive indices of the lens elements may be the same) or from different materials. In the case of the lens elements being formed from different materials, the difference in refractive index between lens elements 34-1 and 34-2 may be less than 0.3, less than 0.2, less than 0.1, less than 0.05, less than 0.03, less than 0.01, etc.

Optically clear adhesive 44 may have a different refractive index than lens elements 34-1 and 34-2 such that the image light is refracted when entering and exiting the optically clear adhesive. The difference in refractive index between OCA 44 and lens element 34-1 may be greater than 0.05, greater than 0.1, greater than 0.2, greater than 0.3, greater than 0.4, etc. The difference in refractive index between OCA 44 and lens element 34-2 may be greater than 0.05, greater than 0.1, greater than 0.2, greater than 0.3, greater than 0.4, etc.

As shown in FIG. 9, a first surface S1 receives the light from optical combiner 36. Image light 22 is refracted when entering lens element 34-1 through surface S1. The image light is then incident upon surface S2 of lens element 34-1. A reflective layer 38-1 is formed on surface S2 and reflects the image light 22 towards surface S3. The image light is refracted when passing through surface S3 from lens element 34-1 into OCA 44. The image light is then refracted again when passing through surface S4 from OCA 44 into lens element 34-2. The image light is then incident upon surface S5 of lens element 34-2. A reflective layer 38-2 is formed on surface S5 of lens element 34-2 and reflects the image light 22 towards surface S6. Image light 22 is then refracted when exiting lens element 34-2 through surface S6. Surfaces S3 and S4 directly contact OCA 44.

Lens elements 34-1 and 34-2 in FIG. 9 may collectively be referred to as a catadioptric collimating lens 34. Lens 34 of FIG. 9 refracts the image light four times (once at surface S1, once at surface S3, once at surface S4, and once at surface S6) and reflects the image light twice (once at surface S2 and once at surface S5).

After exiting lens element 34-2, image light 22 is incident upon waveguide 26 and may be coupled into the waveguide by input coupler 28.

Each one of surfaces S1, S2, S3, S4, S5, and S6 in FIG. 9 may be a planar surface, a convex surface (e.g., a spherically convex surface, a cylindrically convex surface, or an cylindrically concave surface, or an aspherically concave surface), or a freeform surface. In one specific example, surface S1 is concave, surfaces S2 and S5 are convex, surfaces S3 and S4 are freeform, and surface S6 is planar.

Lens 34 in FIG. 9 may have a dimension 40 parallel to the X-axis and a dimension 42 parallel to the Y-axis. Dimension 40 may be greater than 5 millimeters, greater than 6 millimeters, greater than 7 millimeters, less than 10 millimeters, less than 8 millimeters, etc. Dimension 42 may be greater than 2 millimeters, greater than 3 millimeters, greater than 5 millimeters, less than 6 millimeters, less than 5 millimeters, less than 4 millimeters, etc. As one specific example, dimension 40 may be less than 7 millimeters and dimension 42 may be less than 4 millimeters. Lens element 34 in FIG. 9 (with 6 functional surfaces defined by two lens elements) may have a smaller volume than lens element 34 in FIG. 3 (with 5 functional surfaces defined by a single lens element).

In FIG. 9, the principle ray of light received at lens 34 from optical combiner 36 is at a non-zero angle 46 relative to the Y-axis. The magnitude of angle 46 may be at least 5 degrees, at least 15 degrees, at least 25 degrees, at least 35 degrees, at least 45 degrees, less than 45 degrees, less than 35 degrees, less than 25 degrees, between 5 degrees and 45 degrees, between 5 degrees and 35 degrees, etc.

FIGS. 6 and 9 show how a given lens element may be split into two lens elements to provide two additional refractive surfaces within lens 34. This provides two additional degrees of freedom within the system. In general, any of the lens elements shown herein in FIGS. 3-9 may be split into multiple lens elements with intervening OCA to create additional refractive surfaces within the lens. It is noted that the OCA may optionally be omitted and an air gap may be included between adjacent lens elements if desired.

FIG. 5 shows how a low-index lens element may be attached to a lens element to provide an additional refractive surface within lens 34. This provides an additional degree of freedom within the system. In general, any of the lens elements shown herein in FIGS. 3-9 may be attached to an additional low-index lens element to create an additional refractive surface within the lens.

In FIGS. 3-7, light is reflected using TIR one time within lens 34 (e.g., at surface S3 in FIG. 3, at portion S3-1 of surface S3 in FIGS. 4 and 5, at portion S5-1 of surface S5 in FIG. 6, and at portion S1-2 of surface S1 in FIG. 7). It is noted that an additional reflective layer 38 may instead be included at these surfaces instead of relying on TIR. This may allow additional flexibility within the system (as the lens will not be constrained to using TIR at this surface).

The example in FIGS. 3-7 of the display modules and optical combiner being formed on the negative Y-side of waveguide 26 (e.g., on the same side of the waveguide as the eye box) and catadioptric lens 34 being formed on the positive Y-side of the waveguide 26 (e.g., on the opposite side of the waveguide as the eye box) is merely illustrative. If desired, this arrangement may be flipped and the display modules and optical combiner may be formed on the positive Y-side of waveguide 26 (e.g., on the opposite side of the waveguide as the eye box) and catadioptric lens 34 may be formed on the negative Y-side of the waveguide 26 (e.g., on the same side of the waveguide as the eye box). In FIGS. 8 and 9, the display modules, optical combiner, and catadioptric lens are all formed on the negative Y-side of waveguide 26 (e.g., on the same side of the waveguide as the eye box). If desired, this arrangement may be flipped and the display modules, optical combiner, and catadioptric lens may all be formed on the positive Y-side of waveguide 26 (e.g., on the opposite side of the waveguide as the eye box). Along the X-direction, the display modules, optical combiner, and catadioptric lens may be formed on the nasal side of the display system (e.g., in a region configured to overlap the user's nose when device 10 is worn by the user) or on the temple side of the display system (e.g., in a region configured to overlap the user's temple when device 10 is worn by the user).

The foregoing is merely illustrative and various modifications can be made to the described embodiments. The foregoing embodiments may be implemented individually or in any combination.

What is claimed is:

1. A display system comprising:
a waveguide;
a display module that produces image light; and
a catadioptric lens that redirects the image light from the display module to the waveguide, wherein the catadioptric lens is configured to refract the image light at least twice and reflect the image light at least twice.

2. The display system defined in claim 1, wherein the catadioptric lens comprises a single lens element with a first surface that refracts the image light, a second surface that reflects the image light, a third surface that reflects the image light, a fourth surface that reflects the image light, and a fifth surface that refracts the image light.

3. The display system defined in claim 2, wherein the catadioptric lens comprises a first mirror on the second surface and a second mirror on the fourth surface.

4. The display system defined in claim 3, wherein the third surface reflects the image light using total internal reflection.

5. The display system defined in claim 1, wherein the catadioptric lens comprises a single lens element with a first surface that refracts the image light, a second surface that reflects the image light, a third surface that both reflects and refracts the image light, and a fourth surface that reflects the image light.

6. The display system defined in claim 5, wherein the catadioptric lens comprises a first mirror on the second surface and a second mirror on the fourth surface.

7. The display system defined in claim 5, wherein the third surface has a first portion that reflects the image light and a second portion that is separate from the first portion and that refracts the image light.

8. The display system defined in claim 1, wherein the catadioptric lens comprises:
a first lens element; and
a second lens element adjacent the first lens element, wherein the second lens element has a lower refractive index than the first lens element.

9. The display system defined in claim 8, wherein the first lens element comprises a first surface that refracts the image light, a second surface that reflects the image light, a third surface that both reflects and refracts the image light, and a fourth surface that refracts the image light and wherein the second lens element comprises a fifth surface that reflects the image light.

10. The display system defined in claim 1, wherein the catadioptric lens comprises:
a first lens element; and
a second lens element that is attached to the first lens element using optically clear adhesive.

11. The display system defined in claim 10, wherein the first lens element comprises a first surface that refracts the image light, a second surface that reflects the image light, and a third surface that directly contacts the optically clear adhesive and that refracts the image light and wherein the second lens element comprises a fourth surface that directly contacts the optically clear adhesive and that refracts the image light, a fifth surface that both reflects and refracts the image light, and a sixth surface that reflects the image light.

12. The display system defined in claim 10, wherein the first lens element comprises a first surface that refracts the image light, a second surface that reflects the image light, and a third surface that directly contacts the optically clear adhesive and that refracts the image light and wherein the second lens element comprises a fourth surface that directly contacts the optically clear adhesive and that refracts the image light, a fifth surface that reflects the image light, and a sixth surface that refracts the image light.

13. The display system defined in claim 1, wherein the catadioptric lens comprises a single lens element with a first surface that refracts the image light when the image light enters the single lens element, reflects the image light, and refracts the image light when the image light exits the single lens element, a second surface that reflects the image light, and a third surface that reflects the image light.

14. The display system defined in claim 1, wherein the catadioptric lens comprises a single lens element with a first surface that refracts the image light, a second surface that reflects the image light, a third surface that reflects the image light, and a fourth surface that refracts the image light.

15. The display system defined in claim 1, wherein the waveguide has first and second opposing sides, wherein the display module is formed on the first side of the waveguide, and wherein the catadioptric lens is formed on the second side of the waveguide.

16. The display system defined in claim 1, wherein the waveguide has first and second opposing sides and wherein the display module and the catadioptric lens are both formed on the first side of the waveguide.

17. The display system defined in claim 1, wherein the image light passes through the waveguide before entering the catadioptric lens.

18. The display system defined in claim 1, wherein the waveguide extends within a plane, wherein the plane has a surface normal, and wherein the image light is received by the catadioptric lens at a non-zero angle relative to the surface normal.

19. A display system comprising:
a waveguide;
a display module that produces image light; and
a catadioptric lens that redirects the image light from the display module to the waveguide, wherein the catadioptric lens comprises:
a first lens element;
a second lens element; and
optically clear adhesive between the first and second lens elements, wherein the first lens element has a first surface that directly contacts the optically clear adhesive and a second surface that is coated with a first mirror, wherein the second lens element has a third surface that directly contacts the optically clear adhesive and a fourth surface that is coated with a second mirror, wherein the image light is refracted at both the first and third surfaces, and wherein the image light is reflected at both the second and fourth surfaces.

20. A display system comprising:
a waveguide;
a display module that produces image light; and
a catadioptric lens that redirects the image light from the display module to the waveguide, wherein the catadioptric lens comprises:
a first lens element having a first refractive index;
a second lens element having a second refractive index that is lower than the first refractive index; and
optically clear adhesive between the first and second lens elements, wherein the optically clear adhesive has the second refractive index and wherein the second lens element has a surface that is coated with a mirror.
